(19) United States
(12) Patent Application Publication
(10) Pub. No.: US 2010/0013371 A1
(43) Pub. Date: Jan. 21, 2010

(54) ELECTRODE MEMBER FOR COLD CATHODE FLUORESCENT LAMP

(75) Inventors: Yoshihiro Nakai, Osaka (JP); Kazuo Yamazaki, Osaka (JP)

Correspondence Address: DRINKER BIDDLE & REATH (DC), 1500 K STREET, N.W., SUITE 1100, WASHINGTON, DC, 20005-1209, US

(73) Assignees: SUMITOMO ELECTRIC INDUSTRIES, LTD, OSAKA (JP); SUMIDEN FINE CONDUCTORS CO., LTD, OSAKA (JP)

(21) Appl. No.: 12/515,826

(22) PCT Filed: Nov. 22, 2007
(86) PCT No.: PCT/JP2007/001289

§ 371 Date: May 21, 2009

(30) Foreign Application Priority Data
Nov. 24, 2006 (JP) 2006-317300

(51) Int. Cl. H01J 1/62; H01J 1/00; H01J 9/14

(52) U.S. Cl. 313/491; 313/311; 445/52

(57) ABSTRACT

An electrode member for a cold cathode fluorescent lamp which is excellent in sputtering resistance and a discharge property, and which is excellent in productivity, a method of producing the electrode member, and a cold cathode fluorescent lamp are provided.

A cold cathode fluorescent lamp 1 includes a glass tube 20 and electrode members 10 arranged in the tube 20.

Each of the electrode members 10 includes an electrode main body portion 11 having a bottomed tubular shape and a lead portion 12 arranged at a sealing portion of the glass tube 20, and the portions 11 and 12 are integrally formed. The electrode members 10 contain at least one type of element selected from Ti, Hf, Zr, V, Nb, Mo, W, Sr, Ba, B, Th, Al, Y, Mg, In, Ca, Sc, Ga, Ge, Ag, Rh, Ta, and rare earth elements (other than Y and Sc) in a total amount in the range of 0.01 to 5.0 percent by mass, and the balance composed of a Fe—Ni alloy and impurities. Since the alloy constituting the electrode members 10 contains a Fe—Ni alloy as a major component, the alloy has a thermal expansion coefficient close to that of glass and is excellent in plastic formability. Since the alloy constituting the electrode members 10 contains a specific additional element, the alloy is excellent in sputtering resistance and a discharge property.

### TECHNICAL FIELD

The present invention relates to an electrode member for a cold cathode fluorescent lamp, the electrode member including an electrode main body portion and a lead portion, a method of producing this electrode member, and a cold cathode fluorescent lamp. In particular, the present invention relates to an electrode member in which performance degradation caused by welding an electrode main body portion to a lead portion can be prevented and which is excellent in productivity.

### BACKGROUND ART

Cold cathode fluorescent lamps have been used as various light sources such as a light source for irradiating an original document in a copying machine, an image scanner, or the like and a light source as a backlight for a liquid crystal display monitor of a personal computer or for a liquid crystal display device (liquid crystal display) of a liquid crystal television or the like. A cold cathode fluorescent lamp is typically provided with a cylindrical glass tube that has a fluorescent material layer on its inner wall surface, and a pair of electrodes each having a bottomed tubular shape (cup shape) arranged at both ends of the glass tube (refer to, for example, Patent Documents 1 and 2). A rare gas and mercury are sealed inside the glass tube. A lead wire is welded to a bottom end face of each of the electrodes (refer to paragraph 0006 in Patent Document 1 and paragraph 0003 in Patent Document 2), and a voltage is applied through the lead wires. The fluorescent lamp emits light through the following process: By applying a high voltage between the two electrodes, electrons in the glass tube are made to collide with the electrodes to emit electrons from the electrodes (to cause electric discharge). The interaction between this electric discharge and the mercury in the tube generates ultraviolet light, and the fluorescent material emits light using the ultraviolet light.

A typical example of the material for forming the above electrode is nickel, and other examples thereof include molybdenum, niobium, and tungsten (refer to the prior art in Patent Documents 1 and 2). An electrode side portion of the lead wire is fixed to a sealing portion of the glass tube, and thus the lead wire is made of a material having a thermal expansion coefficient close to that of glass so as to closely attach to the glass. Typical examples of such a material include iron-nickel-cobalt alloys called kovar, and composite alloys called Dumet in which a core member made of an iron-nickel alloy is covered with a copper layer (refer to Patent Document 2). In addition, Patent Documents 1 and 2 describe molybdenum and tungsten as the material for forming a lead wire.

In the case where an electrode and a lead wire are separately prepared, and they are integrated by welding, the electrode may be detached from the lead wire during lighting of a fluorescent lamp because of connection failure. On the other hand, in an attempt of reliable connection, crystal grains of a metal constituting the electrode are coarsened by heat during welding, and performance of the electrode may be degraded. To solve this problem, Patent Documents 1 and 2 disclose an electrode member in which an electrode and a lead wire are integrally formed. As the material of this electrode member, Patent Document 1 discloses nickel and niobium, and Patent document 2 discloses tungsten and molybdenum.

[Patent Document 1] Japanese Unexamined Patent Application Publication No. 2004-335407

[Patent Document 2] Japanese Unexamined Patent Application Publication No. 2003-242927

### DISCLOSURE OF INVENTION

### Problems to be Solved by the Invention

Although Patent Document 1 does not disclose a method of producing the electrode member, nickel and niobium are excellent in plastic formability, and thus it is believed that the electrode member can be produced by plastic working. However, nickel has poor sputtering resistance, that is, a sputtering rate of nickel is high. Therefore, when an electrode made of nickel is used in a fluorescent lamp, the rate of electrode consumption is high, and thus the lifetime of the fluorescent lamp becomes short. Sputtering refers to a phenomenon in which a substance in a glass tube collides with an electrode, and thereby a substance (nickel atom in this case) constituting the electrode is sputtered in the glass tube to deposit on the inner wall surface of the tube. Nickel atoms sputtered by the sputtering are combined with mercury to readily produce an amalgam. Consumption of mercury due to the formation of the amalgam also decreases the lifetime of a fluorescent lamp. Furthermore, when mercury is consumed, emission of ultraviolet light is not sufficiently performed, and thus the luminance of the fluorescent lamp significantly decreases. This decrease in the luminance also leads to the end of the fluorescent lamp. Furthermore, the work function of nickel is relatively large. Therefore, in the case where an electrode made of nickel is used as a fluorescent lamp, it is necessary to increase the electric power supplied to the electrode. This is not preferable in view of a recent energy saving effort. The work function refers to the minimum energy required for taking out a single electron from a solid surface to the vacuum. A material having a small work function is a material from which an electrode is easily taken out, in other words, a material in which electric discharge easily occurs. In addition, since the thermal expansion coefficient of nickel is significantly different from that of glass, as described in Patent Document 1, it is necessary to join a metal body (e.g., tungsten) having a thermal expansion coefficient close to that of bead glass to the outer periphery of a lead wire. Patent document 1 describes that this connection is formed by welding. In such a case, performance of the electrode may be degraded by heat during welding.

In contrast to the nickel mentioned above, niobium, molybdenum, and tungsten have small work functions and are excellent in sputtering resistance. However, niobium and molybdenum have poor oxidation resistance, and thus a surface of an electrode is easily oxidized by heat during sealing of a glass tube. The formation of an oxide film on the surface of the electrode decreases a discharge property of the electrode. Furthermore, molybdenum and tungsten have very poor cold plastic formability. Therefore, an electrode member made of molybdenum or tungsten must be formed by injection molding, as described in Patent Document 2, and thus the productivity is low. Furthermore, niobium, molybdenum, and tungsten are generally expensive, resulting in a high cost.

Accordingly, it is a main object of the present invention to provide an electrode member for a cold cathode fluorescent lamp which is excellent in properties required for an electrode, such as sputtering resistance and a discharge property (electron emission characteristic), and which is excellent in productivity. It is another object of the present invention to provide a method of producing the electrode member for a cold cathode fluorescent lamp. Furthermore, it is another object of the present invention to provide a cold cathode fluorescent lamp including the electrode member.

### Means for Solving the Problems

If an electrode member in which an electrode and a lead wire are integrated can be produced by plastic working, the productivity can be improved. Accordingly, the material for forming an electrode member is desirably excellent in plastic formability. Alloys such as iron-nickel-cobalt alloys that are used as a material for forming a lead wire have excellent plastic formability. In addition, these alloys have a thermal expansion coefficient close to that of glass. Consequently, the inventors of the present invention have studied on the formation of an electrode member made of such an alloy. However, an electrode made of the above alloy has a poor discharge property and sputtering resistance, and does not have satisfactory properties required for the electrode. Therefore, in order to improve the discharge property and sputtering resistance, the inventors of the present invention have studied on the composition of a material for forming an electrode member containing the above alloy as a major component, and completed the present invention.

An electrode member for a cold cathode fluorescent lamp of the present invention includes an electrode main body portion having a bottomed tubular shape, and a lead portion connected to a bottom end face of the electrode main body portion. The electrode main body portion and the lead portion are integrally formed. Furthermore, the electrode main body portion and the lead portion contain at least one type of element selected from Ti, Hf, Zr, V, Nb, Mo, W, Sr, Ba, B, Th, Al, Y, Mg, In, Ca, Sc, Ga, Ge, Ag, Rh, Ta, and rare earth elements (other than Y and Sc) in a total amount of 0.01 percent by mass or more and 5.0 percent by mass or less, and the balance composed of a Fe—Ni alloy and impurities.

The electrode member of the present invention can be produced by a production method below. This production method is a method of producing an electrode member for a cold cathode fluorescent lamp in which an electrode main body portion having a bottomed tubular shape and a lead portion connected to a bottom end face of the electrode main body portion are integrally formed, and includes the following steps:

1. A step of preparing a wire material containing at least one type of element selected from Ti, Hf, Zr, V, Nb, Mo, W, Sr, Ba, B, Th, Al, Y, Mg, In, Ca, Sc, Ga, Ge, Ag, Rh, Ta, and rare earth elements (other than Y and Sc) in a total amount of 0.01 percent by mass or more and 5.0 percent by mass or less, and the balance composed of a Fe—Ni alloy and impurities.

2. A step of forging an end portion of the wire material to form the electrode main body portion having the bottomed tubular shape.

According to the electrode member of the present invention, an electrode main body portion and a lead portion are integrally formed. That is, these two portions are not connected by welding or the like, and thus degradation of performance of the electrode main body portion caused by heat during connection by welding or the like can be prevented. In particular, the electrode member of the present invention is made of a Fe—Ni-based alloy containing a Fe—Ni alloy (iron-nickel alloy) as a major component and a specific additional element. This alloy is excellent in plastic formability. Therefore, a wire material made of this alloy can be easily produced by plastic working. In addition, by performing plastic working on an end portion of this wire material, the electrode member of the present invention in which an electrode main body portion having a bottomed tubular shape and a linear lead portion are integrated can be easily produced. Accordingly, the electrode member of the present invention is excellent in productivity. Furthermore, since the electrode member of the present invention contains a Fe—Ni alloy as a major component, the thermal expansion coefficient of the lead portion is close to that of glass. Accordingly, the lead portion of the electrode member of the present invention can be satisfactorily closely attached to glass without interposing a specific metal body therebetween. Furthermore, since the electrode member of the present invention is made of a material in which a specific additional element is incorporated in a Fe—Ni alloy in a specific range, the electrode member is excellent in properties desired for an electrode, such as a discharge property, sputtering resistance, and oxidation resistance. Accordingly, by using the electrode member of the present invention, a cold cathode fluorescent lamp having a high luminance and a long lifetime can be obtained. In addition, since the electrode member of the present invention contains a relatively inexpensive Fe—Ni alloy as a major component, the material cost can be reduced. Furthermore, since the electrode member of the present invention can be produced by plastic working, the production cost can be reduced. Accordingly, the electrode member of the present invention is economically advantageous.

The present invention will now be described in more detail. The electrode member of the present invention is made of a Fe—Ni-based alloy containing a Fe—Ni alloy as a major component (95 percent by mass or more) and a specific additional element added to this alloy. Since a Fe—Ni alloy is contained as a major component, the thermal expansion coefficient of a lead portion substantially depends on the thermal expansion coefficient of the Fe—Ni alloy. The lead portion is connected to a glass tube of a cold cathode fluorescent lamp and a glass bead (an inclusion used for easily connecting the glass tube to the lead portion by being joined to the outer periphery of the lead portion). Consequently, the Fe—Ni alloy used as the major component is preferably a Fe—Ni alloy having a thermal expansion coefficient close to that of glass constituting the glass tube and the glass bead. The thermal expansion coefficient (30° C. to 450° C.) of glass constituting the glass tube or the like is about 40×10⁻⁷ to 110×10⁻⁷/° C. Specific examples of the composition of a Fe—Ni alloy having a thermal expansion coefficient close to this thermal expansion coefficient include the following. The contents (percent by mass) of Ni, Co, and Cr below are represented on the assumption that the Fe—Ni alloy that does not contain additional elements described below (elements other than Ni, Co, and Cr) is 100 percent by mass. The contents (percent by mass) of Ni, Co, and Cr in a Fe—Ni-based alloy that contains additional elements described below are also preferably within the following ranges.

1. An alloy containing, in terms of percent by mass, 28% to 30% of Ni, 17% to 20% of Co, and balance composed of Fe and impurities. The thermal expansion coefficient (30° C. to 450° C.) of this alloy is about 45×10⁻⁷ to 55×10⁻⁷/° C.

2. An alloy containing, in terms of percent by mass, 41% to 52% of Ni, and balance composed of Fe and impurities. The thermal expansion coefficient (30° C. to 450° C.) of this alloy is about 55×10⁻⁷ to 110×10⁻⁷/° C.

3. An alloy containing, in terms of percent by mass, 41% to 46% of Ni, 5% to 6% of Cr, and balance composed of Fe and impurities. The thermal expansion coefficient (30° C. to 450° C.) of this alloy is about 80×10⁻⁷ to 110×10⁻⁷/° C.

Commercially available Fe—Ni alloys may be used as these Fe—Ni alloys. By using such a Fe—Ni alloy as the material for forming an electrode member, the thermal expansion coefficient (the average in the range of 30° C. to 450° C.) of the lead portion can be controlled to be 45×10⁻⁷/° C. or more and 110×10⁻⁷/° C. or less.

The additional element incorporated in the above major component is at least one type of element selected from Ti, Hf, Zr, V, Nb, Mo, W. Sr, Ba, B, Th, Al, Y, Mg, In, Ca, Sc, Ga, Ge, Ag, Rh, Ta, and rare earth elements (other than Y and Sc). One type of element or two or more types of element may be incorporated. The content of the additional element is 0.01 percent by mass or more and 5.0 percent by mass or less. In the case where plurality types of elements are used as additional elements, the total content is controlled so as to satisfy the above range. If the content of the additional element is less than 0.01 percent by mass, it is difficult to achieve an advantage due to the incorporation of the additional element, namely, an improvement in the discharge property and sputtering resistance. This advantage tends to improve with an increase in the content of the additional element, but it is believed that the advantage is saturated at 5.0 percent by mass. If the content of the additional element exceeds 5.0 percent by mass, plastic formability of the alloy tends to decrease. Furthermore, an increase in the content of the additional element increases the material cost. The total content of the additional element is more preferably 0.1 percent by mass or more and 3.0 percent by mass or less, and further preferably 0.1 percent by mass or more and 2.0 percent by mass or less.

Among the above additional elements, in particular, at least one type of element selected from Y, Nd, Ca, Ge, and misch metals (M.M.) are preferable from the following standpoints.

Yttrium (Y,) neodymium (Nd), and M.M. are precipitation-type elements and advantageous in that when a precipitate is present in grain boundaries, a growth of crystal grains of a metal constituting the electrode main body portion can be suppressed, and oxidation of a surface of the electrode main body portion can be inhibited, the growth of crystal grains and the oxidation being caused by heat during sealing of a glass tube or the like. Therefore, Y, Nd, and M.M can contribute to an improvement in the electron emission characteristic and sputtering resistance of the electrode main body portion. In particular, in the case where Y is added, Y is preferably added in combination with at least one type of element selected from Ca, Ti, Si, and Mg. By adding Ca, Ti, Si, or Mg together with Y, the following advantages can be expected. Specifically, oxidation of Y is prevented (deoxidation effect), Y is easily uniformly incorporated in an alloy, and degradation of plastic formability due to the incorporation of Y is suppressed. The total content of Y and the at least one type of element selected from Ca, Ti, Si, and Mg is controlled to be within the above-described range (0.01 to 5.0 percent by mass). The total content of the at least one type of element selected from Ca, Ti, Si, and Mg is preferably in the range of 0.5% to 80% of the content of Y when the content of Y is assumed to be 100%.

When Ca is incorporated in combination with Y as described above, besides the above advantages of the addition of Y, an advantage of improvement in oxidation resistance of the alloy is achieved. Therefore, Ca can contribute to an improvement in the electron emission characteristic and sputtering resistance of the electrode member. Germanium (Ge) has a small work function and has an advantage of decreasing the work function of the alloy. Accordingly, it is expected that addition of Ge can increase the discharge property of the electrode member and contribute to realization of a high luminance of a fluorescent lamp.

In the case where, among the elements selected from Y, Nd, Ca, Ge, and M.M., only one type of element is used as the additional element, the content thereof is preferably 0.1 percent by mass or more and 2.0 percent by mass or less, and more preferably 0.1 percent by mass or more and 1.0 percent by mass or less. In the case where, among the elements selected from Y, Nd, Ca, Ge, and M.M., plurality types of elements are used as the additional elements, the total content thereof is preferably 0.1 percent by mass or more and 3.0 percent by mass or less.

For other elements, it is believed that among the additional elements, Al and Si have a significant advantage of extending the lifetime of the electrode member.

The work function of the electrode member of the present invention made of a Fe—Ni-based alloy containing the above additional element is small; less than 4.7 eV Accordingly, it is expected that the electrode member of the present invention is excellent in a discharge property and contributes to realization of high luminance of a fluorescent lamp. Alternatively, in the case where the electrode member of the present invention is used at the same luminance as a known electrode, it is believed that the lifetime of the fluorescent lamp can be further extended. Furthermore, the electrode member of the present invention readily emits electrons. Accordingly, even when a current supplied to the electrode member is small, the luminance of the fluorescent lamp can be increased, and thus power consumption can also be reduced. The work function can be changed by appropriately adjusting the type and content of additional element. As the content of the additional element increases, the work function readily decreases. In addition, as the work function decreases, the luminance tends to increase. Accordingly, the work function is preferably as small as possible. The work function is preferably 4.3 eV or less, and particularly preferably 4.0 eV or less. The work function can be measured by, for example, ultraviolet photoelectron spectrometry.

An etching rate of the electrode member of the present invention made of a Fe—Ni-based alloy containing the above additional element is low; less than 20 nm/min. Here, when sputtering occurs, a pit is formed in a portion of an electrode where atoms constituting the electrode are emitted, and consequently, the surface is roughened. In an electrode in which sputtering easily occurs, the depth of the pit formed per unit time increases. The average depth of the pit formed per unit time is referred to as “etching rate”, which has substantially the same meaning as the sputtering rate. An electrode having a low etching rate is an electrode in which sputtering does not readily occur. The electrode member of the present invention has good sputtering resistance. Accordingly, when the electrode member of the present invention is used in a fluorescent lamp, a decrease in the luminance of the lamp can be suppressed even after a long time use. Thus, the electrode member of the present invention can contribute to extending the lifetime of a fluorescent lamp. Alternatively, in the case where the electrode member of the present invention is used in a fluorescent lamp and the fluorescent lamp is used so that the lifetime thereof is the same as that of a known electrode, a high luminance state can be maintained for a long time. Thus, the electrode member of the present invention can contribute to realization of high luminance of a fluorescent lamp. In addition, in the case where the electrode member of the present invention is used in a fluorescent lamp, even when the luminance is increased by means of a large current, sputtering does not readily occur. Furthermore, the electrode member of the present invention contains a reduced amount of Ni. Accordingly, even if sputtering occurs, formation of amalgam is suppressed, and thus a decrease in the luminance and a decrease in the lifetime of a fluorescent lamp can be suppressed. The etching rate can be changed by appropriately adjusting the type and content of additional element. When the content of the additional element increases, the etching rate readily decreases. In addition, as the etching rate decreases, the lifetime of the fluorescent lamp tends to increase. Accordingly, the etching rate is preferably as low as possible and preferably 17 nm/min or less. The etching rate is measured as follows. An electrode member is placed in a vacuum device, and ion irradiation of an inert element is performed for a predetermined period of time. The surface roughness of the electrode member after the irradiation is measured, and a value calculated by dividing the surface roughness by the irradiation time (surface roughness/irradiation time) is defined as the etching rate.

The electrode member of the present invention is produced by performing plastic working, such as forging, on an end portion of a wire material made of a Fe—Ni-based alloy containing the specific additional element described above. Consequently, the electrode member can include an electrode main body portion having a bottomed tubular shape at the end portion, and a linear lead portion at another end portion. The other end portion of the wire material may be subjected to cutting work as required so that the wire diameter of the lead portion is adjusted. Alternatively, the electrode member of the present invention can be produced by performing cutting work of the whole wire material without performing forging. However, production by plastic working is more preferable because the yield is high. Alternatively, the electrode member of the present invention can be produced by casting using a mold. However, production by plastic working is superior in terms of mass productivity.

The above wire material is obtained by, for example, melting→casting→hot rolling→cold drawing, and heat treating. More specifically, Fe, Ni and, as required, Co or Cr, or a commercially available Fe—Ni alloy that is used as a major component, and the above-described additional elements are prepared, and these are melted in a vacuum melting furnace, an air atmosphere furnace, or the like to prepare a molten metal of an alloy. In a case of melting in a vacuum melting furnace, the molten metal is adjusted by, for example, adjusting the temperature of the molten metal. In a case of melting in an air atmosphere furnace, the molten metal is adjusted by, for example, removing or reducing impurities and inclusions in the molten metal by refining or the like, and adjusting the temperature of the molten metal. An ingot is obtained by casting such as vacuum casting. The ingot is hot-rolled to prepare a rolled wire material. The rolled wire material is repeatedly cold-drawn and heat-treated, thus obtaining a wire material made of a Fe—Ni-based alloy in which a specific additional element is contained in a Fe—Ni alloy. The cold drawing is performed such that the rolled wire material has a dimension suitable for forming an electrode main body portion. A final heat treatment (softening treatment) of the wire material is preferably performed in a hydrogen atmosphere or a nitrogen atmosphere at 700° C. to 1,000° C., in particular, at about 800° C. to 900° C.

Plastic working is performed on one end portion of the wire material to form an electrode main body portion having a bottomed tubular shape (cup shape). When the electrode main body portion has such a bottomed tubular shape, an improvement in the sputtering resistance due to a hollow cathode effect can be realized. The alloy constituting the above wiring material contains, as a major component, a Fe—Ni alloy having good plastic formability, and the above-mentioned specific additional element incorporated in this alloy in a specific range. Thereby, a decrease in the plastic formability is suppressed. Accordingly, plastic working, which is a relatively strong working, such as forging can be sufficiently performed on the wiring material. Furthermore, this wiring material is excellent also in cutting workability. Accordingly, the electrode member of the present invention can be easily produced by performing plastic working or cutting working on the wiring material. Furthermore, when the cup-shaped electrode main body portion is produced from a wiring material by plastic working, the yield is high because a waste material is hardly generated in producing the electrode main body portion.

In addition, as a result of an examination made by the inventors of the present invention, it was found that when crystal grains of the alloy constituting the electrode main body portion are fine, an advantage of realizing a long lifetime and a high luminance of a fluorescent lamp including this electrode member can be achieved. Specifically, the average crystal grain size of the alloy constituting the electrode main body portion is preferably 70 μm or less, and particularly preferably 50 μm or less. In the electrode member of the present invention made of a Fe—Ni-based alloy containing the above-mentioned specific additional element, the average crystal grain size of the electrode main body portion is 70 μm or less. The average crystal grain size of the electrode main body portion can be further decreased by adjusting the type and content of additional element. In addition to the adjustment of the type and content of additional element, by adjusting conditions for the final heat treatment in producing the above wiring material, the average crystal grain size can be further decreased. For example, in the final heat treatment, when the heating temperature (heat treatment temperature) is a relatively high temperature and the heating time is short, grain growth can be suppressed. Specifically, the heat treatment temperature is controlled to be 700° C. to 1,000° C., in particular about 800° C., and a wire supplying speed is controlled to be 50° C./sec or more. When the wire supplying speed is increased, the average crystal grain size tends to decrease. Note that in the case where forging is performed on a wire material, the average crystal grain size of the alloy after forging somewhat changes as compared with the average crystal grain size before forging. However, the average crystal grain size of the alloy constituting the electrode main body portion substantially depends on the average crystal grain size of the wire material before forging. Accordingly, when the average crystal grain size of an alloy constituting the wire material is 70 μm or less, the average crystal grain size of the electrode main body portion is also about 70 μm or less.

The electrode member of the present invention made of a Fe—Ni-based alloy containing the specific additional element described above can be suitably used as a discharge component of a cold cathode fluorescent lamp, and can contribute to realization of a high luminance and long lifetime of the fluorescent lamp. Specifically, the fluorescent lamp has a structure including a glass tube the inside of which is hermetically sealed, electrode main body portions each having a bottomed tubular shape and arranged in the glass tube, and lead portions fixed to sealing portions of the glass tube. The lead portion is connected to a bottom end face of the electrode main body portion, and is formed so as to be integrated with the electrode main body portion. In general, a fluorescent material layer is provided on the inner wall surface of the glass tube, and a rare gas and mercury are sealed inside the glass tube. The fluorescent lamp may be a mercury-free fluorescent lamp, in which only a rare gas is sealed inside a glass tube. A typical glass tube is an I-shaped glass tube. Other examples of the glass tube include an L-shaped glass tube and a T-shaped glass tube. In the case of the I-shaped glass tube, a fluorescent lamp may have a pair of electrode members of the present invention, and the two electrode members may be fixed to both ends of the glass tube so that portions of the openings of the electrode main body portions face each other. Alternatively, in a fluorescent lamp having such an I-shaped glass tube, an electrode member may be fixed to only one end of the glass tube. In the case of the L-shaped glass tube, electrode members are fixed to two ends of linear portions, or to three portions, namely, a corner and the two ends. In the case of the T-shaped glass tube, electrode members are fixed to three ends. In the electrode member of the present invention, a glass bead may be joined to the outer periphery of the lead portion. In particular, when the electrode member of the present invention is used in a fluorescent lamp for which a long lifetime and high quality are desired, the electrode member is preferably joined to a glass bead. Examples of the glass tube and glass bead that can be used include those made of hard glass such as borosilicate glass or aluminosilicate glass, and soft glass such as soda lime glass. The type of glass is selected in accordance with the thermal expansion coefficient of the lead portion. Furthermore, in the electrode member of the present invention, an outer lead wire may be connected to an end of the lead portion so that the electrode member has a structure including the outer lead wire.

The electrode member of the present invention made of a Fe—Ni-based alloy having the above specific composition is excellent in oxidation resistance, and thus an oxide film is not readily formed on a surface of the electrode main body portion by heat in producing the electrode member, in sealing the glass tube, and the like. Accordingly, degradation of a discharge property in the electrode main body portion is suppressed. The ease of formation of an oxide film substantially depends on the composition of an alloy constituting the electrode member. For example, in the case where Al is contained as an additional element in a particularly large amount, an oxide film tends to be readily formed. However, by controlling the additional element of the Fe—Ni-based alloy constituting the electrode member of the present invention to be a specific range, the thickness of an oxide film formed on the electrode main body portion can be reduced to 1 μm or less, in particular, 0.3 μm or less. On an electrode member made of a Fe—Ni-based alloy containing at least one type of element selected from Ca, Ge, and Ag as an additional element, the formation of an oxide film is particularly suppressed, and the thickness of the oxide film can be reduced to 0.3 μm or less. In addition, in producing a wire material, when a heat treatment is performed in an atmosphere other than oxygen (atmosphere not containing oxygen), the formation of an oxide film on the electrode main body portion can be prevented.

### Advantages

The electrode member of the present invention made of a Fe—Ni-based alloy having a specific composition has a good electron emission characteristic and sputtering resistance, in addition to good productivity. Accordingly, a cold cathode fluorescent lamp including the electrode member of the present invention can realize a higher luminance and longer lifetime without increasing the size of the electrode.

### BRIEF DESCRIPTION OF DRAWING

FIG. 1 is a cross-sectional view showing the outline structure of a cold cathode fluorescent lamp.

### REFERENCE NUMERALS

1 cold cathode fluorescent lamp
10 electrode member
11 electrode main body portion
12 lead portion
13 outer lead wire
14 glass bead
20 glass tube
21 fluorescent material layer

### BEST MODES FOR CARRYING OUT THE INVENTION

Embodiments of the present invention will now be described.

Electrode members for a cold cathode fluorescent lamp were prepared using alloys having the compositions (Alloy Nos. 1 to 20 and Comparisons 1 to 3) shown in Table I. Each of the electrode members includes an electrode main body portion having a bottomed tubular shape and a lead portion projecting from a bottom end face of the electrode main body portion, wherein the electrode main body portion and the lead portion are integrally formed.

TABLE I

| | Additional element of | | | Additional element | | |
|---|---|---|---|---|---|---|
| Alloy | Fe—Ni alloy (mass %) | | | (mass %) | | |
| No. | Ni | Co | Cr | Type | Total | Balance |
| 1 | 29.0 | 17.4 | — | Ag: 0.6 | 0.6 | Fe and |
| 2 | 28.7 | 19.1 | — | Ge: 4.3 | 4.3 | inevitable |
| 3 | 29.2 | 18.5 | — | Nd: 0.3 | 0.5 | impurities |
| | | | | B: 0.2 | | |
| 4 | 29.1 | 17.8 | — | In: 0.8 | 0.8 | |
| 5 | 28.9 | 17.3 | — | Y: 0.35 | 0.35 | |
| 6 | 28.8 | 18.2 | — | Th: 3.1 | 3.1 | |
| 7 | 29.0 | 17.0 | — | Mo: 0.7 | 0.7 | |
| 8 | 41.2 | — | — | V: 0.45 | 0.65 | |
| | | | | Ca: 0.2 | | |
| 9 | 42.0 | — | — | M.M.: 0.9 | 0.9 | |
| 10 | 46.1 | — | — | Nb: 1.2 | 1.2 | |
| 11 | 45.7 | — | — | Ta: 0.4 | 0.5 | |
| | | | | Sc: 0.1 | | |
| 12 | 50.2 | — | — | Al: 1.1 | 1.15 | |
| | | | | Ba: 0.05 | | |
| 13 | 50.8 | — | — | Ti: 0.6 | 0.7 | |
| | | | | Sr: 0.1 | | |
| 14 | 41.3 | — | 5.1 | Hf: 0.3 | 0.4 | |
| | | | | B: 0.1 | | |
| 15 | 41.6 | — | 5.6 | V: 0.6 | 0.7 | |
| | | | | Mg: 0.1 | | |
| 16 | 41.9 | — | 5.3 | V: 0.3 | 0.4 | |
| | | | | Mg: 0.1 | | |
| 17 | 45.1 | — | 5.9 | Nd: 0.4 | 0.4 | |
| 18 | 45.5 | — | 5.0 | Ga: 0.4 | 2.1 | |
| | | | | W: 1.7 | | |
| 19 | 45.8 | — | 5.7 | Rh: 0.1 | 0.5 | |
| | | | | Zr: 0.4 | | |
| 20 | 45.3 | — | 5.4 | Ge: 0.5 | 0.6 | |
| | | | | Ca: 0.1 | | |
| Comparison 1 | 29.0 | 17.3 | — | — | — | |
| Comparison 2 | 41.1 | — | — | — | — | |
| Comparison 3 | 45.2 | — | 5.8 | — | — | |

M.M.: Misch metal

Each of the electrode members was prepared by forging an end portion of a wire material made of an alloy having a composition shown in Table I, and cutting another end portion thereof. A specific production procedure will now be described. First, a wire material was prepared. A molten metal having the composition shown in Table I was prepared using an ordinary vacuum melting furnace. The temperature of the molten metal was appropriately adjusted, and an ingot was obtained by vacuum casting. The ingot was hot-rolled until a wire diameter was reduced to 5.5 mm, thus preparing a rolled wire material. Cold drawing and a heat treatment were performed on the rolled wire material in combination. A final heat treatment (softening treatment) of the resulting wire material was performed to prepare an annealed material having a wire diameter of 1.6 mm. The softening treatment was performed at a temperature of 800° C. in a hydrogen atmosphere while appropriately selecting a wire supplying speed in the range of 10° C./sec to 150° C./sec. Commercially available Fe (pure Fe (99.0 percent by mass or more of Fe), Ni (pure Ni (99.0 percent by mass or more of Ni), Co (pure Co (99.0 percent by mass or more of Co), and Cr (pure Cr (99.0 percent by mass or more of Cr) were used for the molten metal.

The thermal expansion coefficient (×10⁻⁷/° C.), the average crystal grain size (μm), the work function (eV), and the etching rate (nm/min) of a metal constituting the prepared annealed material were measured. The results are shown in Table II. The thermal expansion coefficient was measured using a columnar test piece by a differential transformer (temperature range: 30° C. to 450° C.). The average crystal grain size of the metal was measured in accordance with a quadrature method described in JISH0501 (1986).

The work function was measured by ultraviolet photoelectron spectrometry. Specifically, as a preliminary treatment, Ar ion etching was performed on the annealed material for several minutes. The work function was then measured using a compound electron spectrometry (manufactured by Physical Electronics, Inc. (PHI), ESCA-5800, accessory UV-150HI) under the following conditions: ultraviolet light source: He I (21.22 eV)/8 W, the degree of vacuum during measurement: 3×10⁻⁹ to 6×10⁻⁹ Torr (0.4×10⁻⁹ to 0.8×10⁻⁹ kPa), the base degree of vacuum before measurement: 4×10⁻¹⁰ Torr (5.3×10⁻¹¹ kPa), applied bias voltage: about −10 V, energy resolution: 0.13 eV, analytical area: 800 μm in diameter of an ellipse, and analytical depth: about 1 nm.

The etching rate was determined as follows. A mirror-polished annealed material was irradiated with argon ions in a vacuum device, and a surface roughness thereof was then measured. The etching rate was determined from the irradiation time and the surface roughness. As a preliminary treatment, the annealed material was partly masked, and the ion irradiation was then performed.

The ion irradiation was performed with an X-ray photoelectron spectrometer (manufactured by PHI, Quantum-2000), under the following conditions: accelerating voltage: 4 kV, ion species: Ar⁺, irradiation time: 120 min, degree of vacuum: 2×10⁻⁸ to 4×10⁻⁸ Torr (2.7×10⁻⁹ to 5.3×10⁻⁹ kPa), argon pressure: about 15 mPa, and incidence angle: about 45 degrees with respect to a sample surface.

The surface roughness was measured with a contact probe profilometer (manufactured by Vecco Instruments, Dektak-3030) under the following conditions: probe: diamond, radius=5 μm, probe pressure: 20 mg, scan range: 2 mm, and scanning rate: Medium. For the annealed material, the average depth of pits in an area (area that is not masked) where the pits were formed on a surface by the ion irradiation was defined as the surface roughness. A value represented by surface roughness/irradiation time (120 min) was defined as the etching rate.

Next, the prepared annealed wire material was cut to a predetermined length (4.0 mm). Cold forging was performed on an end portion (a portion ranging from an end face to a position 1 mm distant from the end face in the longitudinal direction) of the short material to form a cup-shaped electrode main body portion. Cutting work was performed on another end portion thereof to form a linear lead portion. As a result, an electrode member in which the cup-shaped electrode main body portion and the linear lead portion are integrated with each other could be obtained from all the annealed materials having any composition. The electrode main body portion had an outer diameter of 1.6 mm, a length of 3.0 mm, an inner diameter of a portion of an opening of 1.4 mm, a depth of 2.6 mm, and a thickness of a bottom portion of 0.4 mm. The lead portion had an outer diameter of 0.6 mm and a length of 3 mm.

For the prepared electrode members, the thickness (μm) of an oxide film formed on a surface of the electrode main body portion. The results are shown in Table II. The thickness of the oxide film was determined by cutting the electrode member, and analyzing the surface of the electrode main body portion by Auger electron spectroscopy.

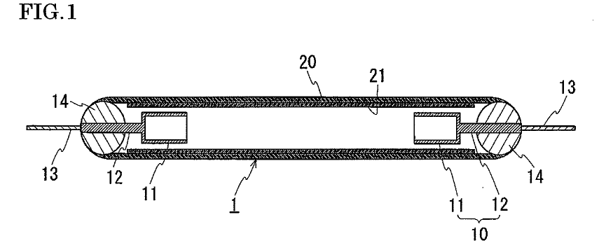

Next, a cold cathode fluorescent lamp 1 shown in FIG. 1 was prepared using the electrode member. The cold cathode fluorescent lamp 1 includes an I-shaped glass tube 20 having a fluorescent material layer 21 on the inner wall surface thereof, and a pair of electrode members 10 arranged at both ends of the glass tube 20. Each of the electrode members 10 includes an electrode main body portion 11 having a bottomed tubular shape and a lead portion 12 that is integrally formed with the electrode main body portion 11. A procedure of preparing a fluorescent lamp including such electrode members 10 is as follows.

A glass bead 14 is inserted into the outer periphery of the lead portion 12, and an outer lead wire 13 composed of a copper-clad Ni alloy wire is then welded to the end of the lead portion 12. Subsequently, the glass bead 14 is fusion-bonded to the outer periphery of the lead portion 12. Two such products in which the electrode member 10, the outer lead wire 13, and the glass bead 14 are integrated with each other (electrode members each including the outer lead wire and the glass bead) are prepared. An I-shaped glass tube 20 which has a fluorescent material layer (halophosphate layer in this test) 21 on the inner wall surface thereof and both ends of which are opened is prepared. One of the integrated products is inserted into an end of the open tube 20, and the glass bead 14 is fusion-bonded to the tube 20. Thus, the end of the tube 20 is sealed and the electrode member 10 (lead portion 12) is fixed to the tube 20. Next, evacuation is performed from the other end of the open glass tube 20, and a rare gas (Ar gas in this test) and mercury are introduced thereto. The other integrated product is fixed to the tube 20 by the same manner, and the tube 20 is sealed. The cold cathode fluorescent lamp 1 in which the portions of the openings of the pair of electrode main body portions 11 are arranged in the glass tube 10 so as to face each other is obtained by this procedure.

As for the glass beads and the glass tube, those made of borosilicate glass (thermal expansion coefficient: 51×10⁻⁷/° C.) were used for the fluorescent lamps of Sample Nos. 1 to 7, and 30 in Table II, and those made of soda lime glass (thermal expansion coefficient: 90×10⁻⁷/° C.) were used for the fluorescent lamps of Sample Nos. 8 to 20, 31, and 32.

A pair of the integrated products described above are prepared for the electrode members having respective compositions, and cold cathode fluorescent lamps are prepared using these integrated products. The luminance and the lifetime of the prepared fluorescent lamps were examined. In this test, each of the center luminance (43,000 cd/m²) and the lifetime of the cold cathode fluorescent lamp of Sample No. 30 including the electrode members composed of Comparison 1 was assumed to be 100, and the luminance and the lifetime of the other Sample Nos. 1 to 20, 31, and 32 were relatively determined. The results are shown in Table II. Note that the time it takes for the center luminance to decrease to 50% was defined as the lifetime.

TABLE II

| | | Thermal expansion | Average crystal | Thickness of | | | | |
|---|---|---|---|---|---|---|---|---|
| Sample | Alloy | coefficient | grain size | ozide film | Work function | Etching rate | | |
| No. | No. | (×10⁻⁷/° C.) | (μm) | (μm) | (eV) | (nm/min) | Luminance | Lifetime |
| 1 | 1 | 51 | 45 | 0.06 | 4.0 | 14.1 | 280 | 280 |
| 2 | 2 | 54 | 36 | 0.05 | 3.4 | 13.5 | 360 | 310 |
| 3 | 3 | 54 | 33 | 0.05 | 3.5 | 13.4 | 350 | 310 |
| 4 | 4 | 52 | 55 | 0.07 | 4.2 | 15.2 | 260 | 230 |
| 5 | 5 | 50 | 28 | 0.04 | 3.3 | 13.1 | 370 | 330 |
| 6 | 6 | 52 | 41 | 0.06 | 3.7 | 13.9 | 320 | 290 |
| 7 | 7 | 50 | 46 | 0.07 | 3.9 | 14.3 | 290 | 270 |
| 8 | 8 | 69 | 25 | 0.03 | 3.2 | 13.2 | 380 | 320 |
| 9 | 9 | 71 | 35 | 0.05 | 3.7 | 13.8 | 310 | 300 |
| 10 | 10 | 83 | 51 | 0.06 | 4.3 | 15.3 | 240 | 230 |
| 11 | 11 | 80 | 49 | 0.05 | 4.2 | 15.0 | 260 | 240 |
| 12 | 12 | 97 | 47 | 0.08 | 4.0 | 14.4 | 280 | 270 |
| 13 | 13 | 100 | 61 | 0.08 | 4.3 | 16.5 | 230 | 190 |
| 14 | 14 | 97 | 57 | 0.07 | 4.3 | 16.1 | 240 | 200 |
| 15 | 15 | 100 | 26 | 0.03 | 3.2 | 13.2 | 380 | 320 |
| 16 | 16 | 101 | 50 | 0.06 | 4.2 | 15.9 | 260 | 210 |
| 17 | 17 | 98 | 29 | 0.04 | 3.4 | 13.3 | 350 | 320 |
| 18 | 18 | 99 | 43 | 0.06 | 3.8 | 13.9 | 300 | 290 |
| 19 | 19 | 103 | 56 | 0.07 | 4.3 | 17.7 | 230 | 170 |
| 20 | 20 | 100 | 34 | 0.04 | 3.5 | 13.7 | 350 | 300 |
| 30 | Comparison 1 | 51 | 89 | 1.1 | 4.7 | 20.0 | 100 | 100 |
| 31 | Comparison 2 | 69 | 90 | 1.2 | 4.7 | 20.0 | 100 | 98 |
| 32 | Comparison 3 | 98 | 89 | 1.2 | 4.7 | 20.0 | 99 | 100 |

As shown in Table II, the fluorescent lamps of Sample Nos. 1 to 20 including electrode members made of a Fe—Ni-based alloy containing a specific element have high luminance and long lifetime, as compared with the fluorescent lamps of Sample Nos. 30 to 32 including electrode members made of a Fe—Ni alloy not containing the specific element. The reasons for this are believed to be as follows: Alloy Nos. 1 to 20 are materials having a small work function and a low etching rate, that is, materials which readily emit electrons and which have a low sputtering rate, as compared with Comparisons 1 to 3, which are made of mere Fe—Ni alloys. In addition, an oxide film is not readily formed on Alloys Nos. 1 to 20, as compared with Comparisons 1 to 3, and thus the electron emission characteristic is not readily degraded. Furthermore, the electrode members made of Alloy Nos. 1 to 20 have small average crystal grain size of 70 μm or less, and this small average crystal grain size contributes to realization of a high luminance and long lifetime of the fluorescent lamps. On the basis of the above results, it is believed that the electrode members made of Alloy Nos. 1 to 20 can be suitably used as materials of a discharge component of a cold cathode fluorescent lamp. Furthermore, in samples produced under the condition of a wire supplying speed of 50° C./sec or more, the average crystal grain size can be further reduced, and it is believed that such electrode members can further contribute to realization of a high luminance and long lifetime of a fluorescent lamp.

Furthermore, for comparison, a cold cathode fluorescent lamp including integrated products each produced by connecting a nickel electrode to a kovar inner lead wire by welding was prepared, and a lighting test was performed. This comparative lamp was prepared as in the fluorescent lamps of Sample Nos. 1 to 20, and 30 to 32, except that the electrode and the inner lead wire were separately prepared, and then connected to each other. One hundred such comparative lamps were prepared. After 1,000 hours passed from the start of lighting, in two lamps among the 100 comparative lamps, the electrodes were detached from the inner lead wires, and a decrease in the luminance was observed. It is believed that these defects were caused by a connection failure. In contrast, as for the fluorescent lamp of Sample No. 5, which included electrode members made of Alloy No. 5, such defects did not occur even after 2,000 hours passed. Accordingly, it is expected that an electrode member which is made of a Fe—Ni-based alloy containing a specific additional element and in which an electrode main body portion and a lead portion are integrally formed can contribute to a cold cathode fluorescent lamp having a high luminance and a long lifetime.

The above-described examples can be modified as required without departing from the main point of the present invention and are not limited to the above-described structure. For example, the use of the glass beads may be eliminated.

### INDUSTRIAL APPLICABILITY

An electrode member of the present invention can be suitably used as a discharge component of a cold cathode fluorescent lamp. A method of producing an electrode member of the present invention can be suitably used in the production of the electrode member of the present invention. A fluorescent lamp of the present invention can be suitably used as a light source of various electric devices such as a light source as a backlight for a liquid crystal display, a light source as a front light for a small display, a light source for irradiating an original document in a copying machine, a scanner, or the like, and a light source for an eraser of a copying machine.

1. An electrode member for a cold cathode fluorescent lamp, the electrode member comprising an electrode main body portion having a bottomed tubular shape; and a lead portion connected to a bottom end face of the electrode main body portion,
wherein the electrode main body portion and the lead portion are integrally formed, and contain at least one type of element selected from Ti, Hf, Zr, V, Nb, Mo, W, Sr, Ba, B, Th, Al, Y, Mg, In, Ca, Sc, Ga, Ge, Ag, Rh, Ta, and rare earth elements (other than Y and Sc) in a total amount of 0.01 percent by mass or more and 5.0 percent by mass or less, and the balance composed of a Fe—Ni alloy and impurities.

2. The electrode member for a cold cathode fluorescent lamp according to claim 1, wherein the electrode main body portion and the lead portion contain at least one type of element selected from Y, Ca, Ge, Nd, and misch metals in a total amount of 0.1 percent by mass or more and 3.0 percent by mass or less, and the balance composed of a Fe—Ni alloy and impurities.

3. The electrode member for a cold cathode fluorescent lamp according to claim 1, wherein the work function of the electrode main body portion is less than 4.7 eV.

4. The electrode member for a cold cathode fluorescent lamp according to claim 1, wherein an etching rate of the electrode main body portion is less than 20 nm/min.

5. The electrode member for a cold cathode fluorescent lamp according to claim 1, wherein the thermal expansion coefficient (the average in the range of 30° C. to 450° C.) of the lead portion is 45×10⁻⁷/° C. or more and 110×10⁻⁷/° C. or less.

6. The electrode member for a cold cathode fluorescent lamp according to claim 1, wherein the average crystal grain size of the metal constituting the electrode main body portion is 70 μm or less.

7. A method of producing an electrode member for a cold cathode fluorescent lamp in which an electrode main body portion having a bottomed tubular shape and a lead portion connected to a bottom end face of the electrode main body portion are integrally formed, the method comprising the steps of:
preparing a wire material containing at least one type of element selected from Ti, Hf, Zr, V, Nb, Mo, W, Sr, Ba, B, Th, Al, Y, Mg, In, Ca, Sc, Ga, Ge, Ag, Rh, Ta, and rare earth elements (other than Y and Sc) in a total amount of 0.01 percent by mass or more and 5.0 percent by mass or less, and the balance composed of a Fe—Ni alloy and impurities; and
forging an end portion of the wire material to form the electrode main body portion having the bottomed tubular shape.

8. A cold cathode fluorescent lamp comprising a glass tube the inside of which is hermetically sealed; an electrode main body portion having a bottomed tubular shape and arranged in the glass tube; and a lead portion connected to a bottom end face of the electrode main body portion and fixed to a sealing portion of the glass tube,
wherein the electrode main body portion and the lead portion are integrally formed, and contain at least one type of element selected from Ti, Hf, Zr, V, Nb, Mo, W, Sr, Ba, B, Th, Al, Y, Mg, In, Ca, Sc, Ga, Ge, Ag, Rh, Ta, and rare earth elements (other than Y and Sc) in a total amount of 0.01 percent by mass or more and 5.0 percent by mass or less, and the balance composed of a Fe—Ni alloy and impurities.

9. The cold cathode fluorescent lamp according to claim 8, wherein the thickness of an oxide film formed on a surface of the electrode main body portion is 1 μm or less.
